(19) United States
(12) Patent Application Publication
(10) Pub. No.: US 2021/0207357 A1
(43) Pub. Date: Jul. 8, 2021

(54) OVERFLOW PIPE SYSTEM

(71) Applicant: Willem Nel VAN STRAATEN, Johannesburg (ZA)

(72) Inventor: Willem Nel VAN STRAATEN, Johannesburg (ZA)

(21) Appl. No.: 17/058,688

(22) PCT Filed: Oct. 16, 2018
(86) PCT No.: PCT/IB2018/058006

§ 371 Date: Nov. 25, 2020

(30) Foreign Application Priority Data
Oct. 18, 2017 (ZA) 2017/07031

(51) Int. Cl. E03F 5/12; E03F 5/02; F16L 41/08

(52) U.S. Cl. CPC E03F 5/12; F16L 41/086; F16L 41/082; E03F 5/021

(57) ABSTRACT

The invention provides for a secondary overflow pipe and connector (10) connectable to a sewer system, the secondary overflow pipe increasing overall capacity of the sewer system during peak flows, the connector (10) connectable to a manhole (16) and shaped to define a funnel to reduce turbulence and facilitate a smooth flow pattern and maximum flow capacity.

### FIELD OF THE INVENTION

This invention relates to a relief sewerage reticulation and more particularly relates to an overflow outlet from a manhole.

### BACK GROUND TO THE INVENTION

Sewerage reticulation is the infrastructure that conveys sewage using sewers.

It encompasses components such as receiving drains, manholes, pumping stations, and screening chambers of the combined sewer or sanitary sewer. Sewerage reticulations ends at the entry to a sewage treatment plant or at the point of discharge into the environment. It is the system of pipes, chambers, manholes, etc. that conveys the sewage or storm water.

The main part of such a sewer system is made up of pipes (i.e. the sewers, or “sanitary sewers”) that convey the sewage from the point of production to the point of treatment or discharge.

In the developed world, sewers are pipes from buildings to one or more levels of larger underground trunk mains, which transport the sewage to sewage treatment facilities.

Vertical pipes (also known as chambers), usually made of precast concrete, called manholes, connect the mains to the surface. Depending upon site application and use, these vertical pipes can be cylindrical, eccentric, concentric or square

The manholes are used for access to the sewer pipes for inspection and maintenance, and as a means to vent sewer gases. They also facilitate vertical and horizontal angles in otherwise straight pipelines.

Pipes conveying sewage from an individual building to a common gravity sewer line are called laterals. Branch sewers typically run under streets, road reserves or servitudes within erven, receiving laterals from buildings along that street and discharge by gravity into trunk sewers at manholes. Larger cities may have sewers called interceptors receiving flow from multiple trunk sewers and conveying the sewerage via outfall sewers to the sewage treatment facilities.

Design and sizing of sanitary sewers considers the population to be served over the anticipated life of the sewer, per capita wastewater production, and flow peaking from timing of daily routines. Minimum sewer diameters are often specified to prevent blockage by solid materials flushed down toilets; and gradients may be selected to maintain flow velocities generating sufficient turbulence to minimize solids deposition within the sewer.

Commercial and industrial wastewater flows are also considered, but diversion of surface runoff to storm drains eliminates wet weather flow peaks of inefficient combined sewers.

Types of sanitary sewer systems that all usually are gravity sewers include:
Combined sewer
Simplified sewerage
Storm drain

Sanitary sewers not relying solely on gravity include:
Vacuum sewer
Effluent sewer

The invention specifically relates to gravity feed sewer systems, but it will be appreciated by those skilled in the art that it may be adapted to include non-gravity feed sewers.

Severe constraints are applied to sewerage, which may result in premature deterioration. These include root intrusion, joint displacement, cracks, and hole formations that lead to a significant volume of leakage with an overall risk for the environment and public health.

Various repair options are available to owners and developers over a large range of costs and potential durability. One option is the application of a cementitious material based on calcium aluminate cement, after a cleaning of the corroded structure to remove loose material and contaminants in order to expose a sound, rough and clean substrate.

Other options may include relaying of larger pipes.

Depending on the concrete condition and contamination, the cleaning can range from simple high pressure jet water cleaning (200 bar) up to real hydro-demolition (2000 bars).

A variety of challenges are experience in sewer system infrastructure, especially in densely populated areas as the initial designed capacity of the sewer system simply becomes insufficient to accommodate an increase in sewer (“overload”) flow due to population densification.

This is especially problematic for developers and the council as an increase in population required new or upgraded infrastructure which is able to accommodate the increase in sewerage. Upgrades in infrastructure may be extremely costly especially in instances where the entire system has to be replaced.

### OBJECT OF THE INVENTION

It is an object of the current invention to at least partially alleviate some of the aforementioned problems by providing a more costs effective method and system to provide for additional capacity in an existing sewer system.

### SUMMARY OF THE INVENTION

The invention provides for a secondary overflow pipe and connector connectable to a sewer system, the secondary overflow pipe increasing overall capacity of the sewer system during peak flows.

The connector may be connectable to a manhole and may be shaped to define a funnel to reduce turbulence and ensure a smooth flow pattern and maximum flow capacity.

The connector may be connectable to the manhole by any suitable means and may include a seal arrangement between the manhole surface and the connector to reduce leakage.

The seal arrangement may be any suitable seal arrangement and may be bitumen seal, alternatively any suitable rubber seal arrangement. The seal arrangement may yet further be cementitious.

The connector may include a flange, the flange being securable to the inside of the manhole, alternatively to the outside surface of the manhole.

The secondary overflow pipe may be connectable to the connector by a spigot and socket joint alternatively a clip fit arrangement.

The connector and secondary overflow pipe may include complementary shaped flanges which flanges may be securable to each other. In a preferred embodiment of the invention, the flanges may be screw threated, alternatively may include multiple fasteners to ensure a secure connection. A seal arrangement may be provided between the connector and secondary overflow pipe to alleviate leakage.

The connector may be provided in a variety of sizes to accommodate different sizes of manholes and pipes.

In a preferred embodiment of the invention, the connector may be securable to the upper end of the manhole above the existing main pipe system so that during peak flows any excess sewerage which pushes up in the manhole may be redirected via the connector and secondary overflow pipe system, effectively increase the capacity of the sewer system during peak. In a preferred embodiment of the invention the overflow sewerage may be redirected to the nearest manhole.

It will be appreciated by those skilled in the art, that the connector and secondary overflow pipe allows for the effective increase in capacity of an existing sewer system without the need to replace the entire existing system, which may be extremely costly and yet further that he existing sewerage flow is unaffected by this system.

### BRIEF DESCRIPTION OF INVENTION

The invention is now further described by way of example.

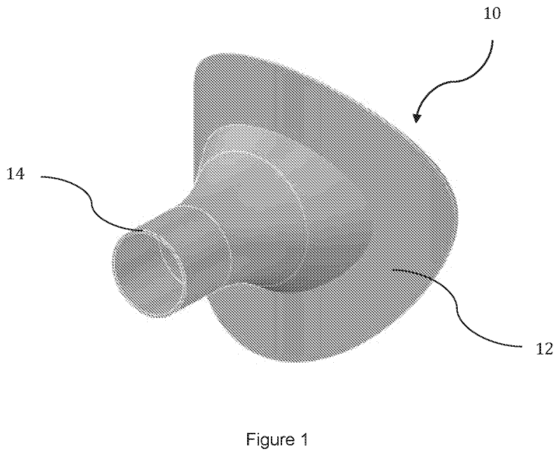

FIG. 1 is a perspective view of the connector according to the invention;

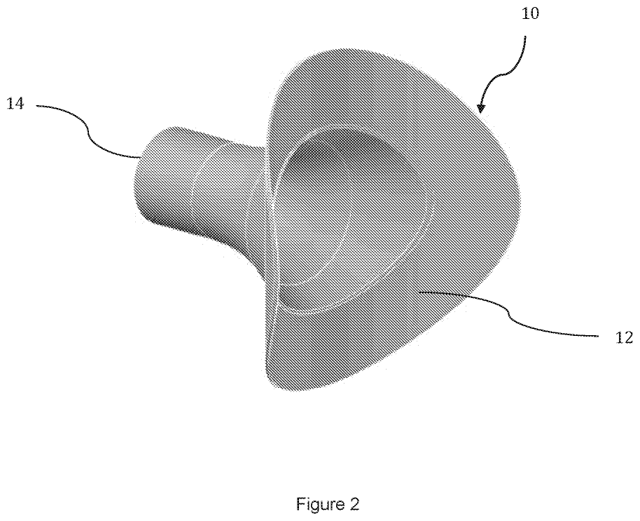

FIG. 2 is another perspective view of the connector according to the invention;

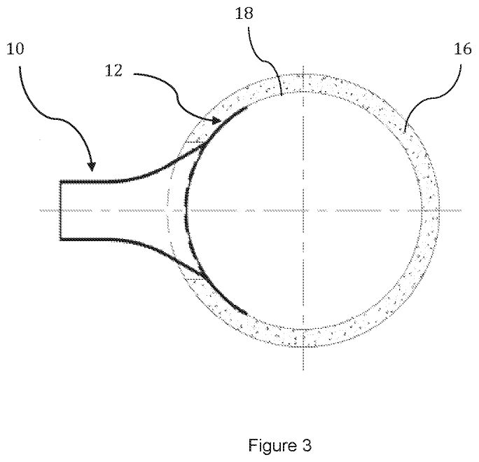

FIG. 3 is a top view of the connector secured within a manhole;

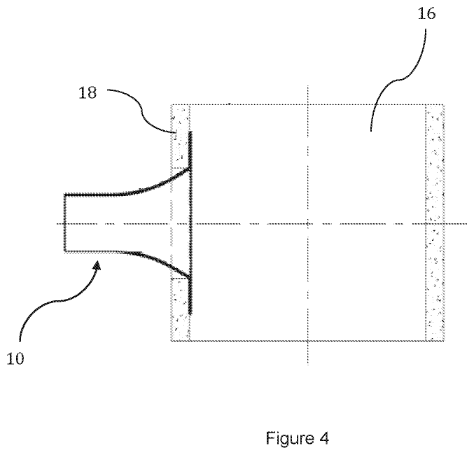

FIG. 4 is a side view of the connector secured within a manhole;

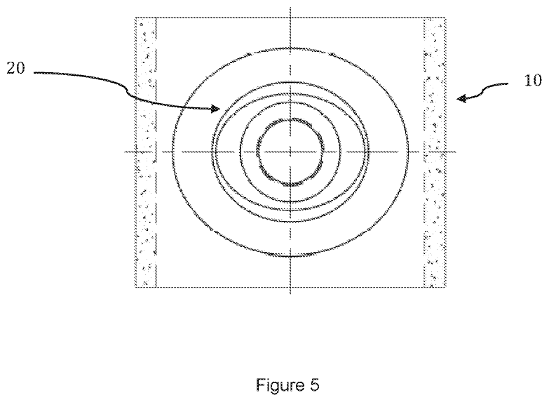

FIG. 5 is a front view of the connector secured within a manhole.

### DESCRIPTION OF PREFERRED EMBODIMENTS

In the following embodiments individual characteristics, given in connection with specific embodiments, may actually be interchanged with other different characteristics that exist in other embodiments.

FIGS. 1 and 2 illustrates a connector 10 which is connectable to a sewer system, the connector 10 in turn connectable to a secondary overflow pipe (not shown) increasing overall capacity of a sewer system during peak flows.

In a preferred embodiment of the invention the connector 10 includes a flange 12 terminating in a conduit 14 to resemble a bell mouth outlet. The conduit 14 is shaped to engage with a secondary overflow pipe (not shown). In a preferred embodiment of the invention the conduit 14 is connectable to the secondary overflow pipe by means of any suitable joinder means known in the art such as a clip fit, spigot and socket joint alternatively maybe screw threaded. It will be appreciated by those skilled in the art that it be hereinbefore described joints between the conduit 14 and the secondary overflow pipe is by no means limiting and may any suitable joinder means be utilised.

It would furthermore be appreciated that the conduit outlet diameter may vary to accommodate various sizes of secondary overflow pipes.

It will yet further be appreciated that the design of the connector to resemble a bell mouth, alternatively a funnel ensures reduced turbulence and a smooth flow pattern to maximise flow capacity.

FIG. 3 illustrates the connector 10 securable within a manhole 16 by any suitable means. In a preferred embodiment of the invention the connector 10 is inserted through an opening provided or created in the manhole side wall 18 so that the conduit 14 extends through the side wall 18 and the flange 12 abuts and creates a natural seal between the inside wall of the manhole 16 to reduce leakage.

A seal arrangement (not shown) may be utilised and may be inserted between the flange 12 and the manhole inner wall 18.

During installation an opening is made along the cut out 20 within the side wall 18 of a manhole 16 which cut out 20 is generally oval in elevation view in order to securely accommodate and receive the connector 10 as is more clearly illustrated in FIGS. 4 and 5. It will be appreciated that the manhole 16 may be square alternatively round in cross section.

It will be appreciated by those skilled in the art that the flange 12 is shaped to accommodate and complement the inner radius of the manhole in which it is to be secured, so that the flange 12 forms a natural seal between the side wall 18 of the manhole 16.

In some embodiments of the invention the seal arrangement consists of a bitumen seal, rubber seal alternatively cementitious.

In another embodiment of the invention the connector 10 is connectable to the outside of the wall 18 of the manhole 16. In this embodiment of the invention the flange 12 is shaped to accommodate and complement the outer radius of the wall 18 and is curable to the wall by means of initiative or fasteners known in the art.

In yet another embodiment of the invention the conduit 14 may include a flange portion which is connectable to a complementary shaped flange provided on the secondary overflow pipe. As was already hereinbefore set out the connection between the secondary overflow pipe and the connector may be any suitable joining means available in the art.

In a preferred embodiment of the invention, the connector 10 is securable to the upper end of the manhole above the existing main pipe system so that during peak flows any excess sewage which pushes up in the manhole is redirected via the connector 10 and secondary overflow pipe system, effectively increase the capacity of the sewer system during peak. In a preferred embodiment of the invention overflow sewage may be redirected to the nearest manhole.

It will be appreciated by those skilled in the art, that the connector and secondary overflow pipe allows for the effective increase in capacity of an existing sewer system without the need to replace the entire existing system, which may be extremely costly and yet further that he existing sewage flow is unaffected by this system.

1. The invention provides for a secondary overflow pipe and connector connectable to a manhole of a sewer system, the connector being shaped to define a funnel to reduce turbulence and ensure a smooth flow pattern and maximum flow capacity, the secondary overflow pipe increasing overall capacity of the sewer system during peak flows.

2. A secondary overflow pipe and connector as claimed in claim 1 wherein the connector includes a seal arrangement between the manhole surface and the connector to reduce leakage.

3. A secondary overflow pipe and connector as claimed in claim 2 wherein the seal arrangement is a bitumen seal.

4. A secondary overflow pipe and connector as claimed in claim 3 wherein the seal arrangement is a rubber seal arrangement.

5. A secondary overflow pipe and connector as claimed in claim 4 wherein the seal arrangement is cementitious.

6. A secondary overflow pipe and connector as claimed in claim 5 wherein the connector includes a flange, the flange being securable to the inside of the manhole.

7. A secondary overflow pipe and connector as claimed in claim 6 wherein the flange is securable to the outside surface of the manhole.

8. A secondary overflow pipe and connector as claimed in claim 7 wherein the secondary overflow pipe is connectable to the connector by a spigot and socket joint.

9. A secondary overflow pipe and connector as claimed in claim 8 wherein the secondary overflow pipe is connectable to the connector by means of a clip fit arrangement.

10. A secondary overflow pipe and connector as claimed in claim 9 wherein the connector and secondary overflow pipe include complementary shaped flanges which flanges is securable to each other.

11. A secondary overflow pipe and connector as claimed in claim 10 wherein the flanges are screw threated and engageable with each other.

12. A secondary overflow pipe and connector as claimed in claim 11 wherein the flanges includes multiple fasteners to ensure a secure connection.

13. A secondary overflow pipe and connector as claimed in claim 12, wherein a seal arrangement is provided between the connector and secondary overflow pipe to alleviate leakage.

14. A secondary overflow pipe and connector as claimed in claims 13 wherein the connector is securable to the operatively upper end of the manhole above the existing main pipe system so that during peak flows any excess sewerage which pushes up in the manhole is redirected via the connector and secondary overflow pipe system, effectively increase the capacity of the sewer system during peak.
